(19) United States
(12) Patent Application Publication
(10) Pub. No.: US 2021/0114135 A1
(43) Pub. Date: Apr. 22, 2021

(54) WELDING METHOD FOR SEALING COOLING-WATER CHANNEL OF ELECTRIC-MACHINE HOUSING

(71) Applicant: Jing-Jin Electric Technologies Co., Ltd., Beijing (CN)

(72) Inventors: Ping YU, Beijing (CN); Haitao JIN, Beijing (CN); Xinliang LING, Beijing (CN); Zhiming YU, Beijing (CN)

(21) Appl. No.: 17/252,987

(22) PCT Filed: Aug. 7, 2018
(86) PCT No.: PCT/CN2018/099210

§ 371 Date: Dec. 16, 2020

(30) Foreign Application Priority Data
Jul. 2, 2018 (CN) 201810709362.6

(51) Int. Cl. B23K 20/12

(52) U.S. Cl. CPC B23K 20/122; B23K 2101/06

(57) ABSTRACT

The present disclosure relates to the technical field of welding, and particularly relates to a welding method for sealing a cooling-water channel of an electric-machine housing. The method includes the steps of: 1) seal the opened ends of the cooling-water channel using the sealing parts to form an S-shaped sealed cooling water channel inside the electric-machine housing; and 2) weld each of the sealing parts and the electric-machine-housing together by using the friction-stir-welding, in one single and complete single-welding-seam mode. The present disclosure utilizes the stirring head having a larger diameter to sufficiently stir-weld each of the sealing parts and the electric-machine housing all at once, i.e., welding in the single-welding-seam mode, so that the welding can be completed at one time, which, as compared with the conventional mode of double-welding-seam mode, has a higher operation efficiency, a better stability, and reduces welding duration by ½ to ⅓.

### TECHNICAL FIELD

The present disclosure relates to the technical field of welding, and particularly relates to a welding method for sealing a cooling-water channel of an electric-machine housing.

### BACKGROUND

Electric machines generate a large amount of heat during its operation, and if the heat is not taken away from the electric-machines' housing, the accumulated heat will burn out the electric machines. A water-channel structure of an electric-machine housing is shown in FIGS. 1-2, wherein in the water-channel structure the coolant flows in the axial direction of the electric-machine housing 1, turns back at the ends, and flows throughout the electric-machine housing 1 in an S shape (which can be determined from FIG. 1). Such a water-channel structure employs an extruded housing, in which the turning channels 32 of the water channel are made at the ends of the electric-machine housing by means of machining, and the two ends of the electric-machine housing 1 are individually welded with sealing parts 2, which can be different in sizes according to the channel design, to seal the water channel. The sealing parts 2 can be in the form of several numbers of sealing blocks 6 or a sealing end ring 7.

The conventional friction-stir welding is usually used to sequentially weld the welding seams on the two sides of the sealing parts 2, i.e., by using a double-welding-seam mode, welding along the grooves, the welding seam I 9, and welding seam II 10 on each sides of the sealing parts 2, as shown in FIGS. 3-4. Such a welding mode has low operation efficiency, poor stability and long welding duration.

### SUMMARY

To tackle the above mentioned problems, an object of the present disclosure is to provide a welding method for sealing a cooling-water channel of an electric-machine housing, to solve the problems of the conventional welding mode that is low operation efficiency, poor in stability and has a long welding duration.

In order to achieve the above objectives, the present disclosure employs the following technical solutions:

A welding method for sealing a cooling-water channel of an electric-machine housing, wherein the method comprises the steps below:

1) seal the opened ends of the cooling-water channel using the sealing parts to form an S-shaped sealed cooling water channel inside the electric-machine housing; and

2) weld each of the sealing parts and the electric-machine-housing by using a friction-stir-welding, to weld in a single-welding-seam mode.

Preferably, the method further comprises, in the step 1), sealing grooves at the ends of the electric-machine housing in a circumferential direction, wherein the sealing grooves are located outside the turning channels, and the sealing parts are placed inside the sealing-part slots.

Preferably, a pilot for supporting the sealing parts is provided at a suitable depth to create the turning channel on the electric-machine housing.

Preferably, sealing-part slots on the electric-machine housing can be machined out to place the sealing parts. The sealing parts that are placed inside mentioned sealing-part slots are called sealing end rings, and the sealing end rings are welded with the electric-machine housing to create the turning channels.

Preferably, multiple sealing slots, where each sealing slot is an independent slot of any shape, are located circumferentially on one or multiple layers on the electric-maching housing ends that corresponds to the shape, number of layers of water-cooling channels' design respectively, and the sealing part that is placed inside these mentioned sealing slots are called sealing end blocks.

The advantages and constructive effects of the present disclosure are as follows: The present disclosure utilizes the stirring head having a larger diameter to sufficiently stir-weld each of the sealing parts and the electric-machine housing all at once, i.e., welding in the single-welding-seam mode, so that the welding can be completed at one time, which, as compared with the conventional mode of double-welding-seam mode, has a higher operation efficiency, a better stability, and reduces welding duration by ½ to ⅓.

### BRIEF DESCRIPTION OF THE DRAWINGS

FIG. 1 is a structural schematic diagram of the water-channel structure of an electric-machine housing;

FIG. 2 is a sectional view of the electric-machine housing;

FIG. 3 is a schematic diagram of the welding mode of a conventional water-channel structure, the double-weld-seam mode;

FIG. 4 is an enlarged view of the point I in FIG. 3;

FIG. 5 is a schematic diagram of the seal-welding mode of the cooling-water channel of the electric-machine housing according to the present disclosure, the single-welding-seam mode;

FIG. 6 is an enlarged view of the point II in FIG. 5;

FIG. 7 is a structural schematic diagram of the sealing by using a ring at an end of the electric-machine housing according to the present disclosure; and

FIG. 8 is a structural schematic diagram of the sealing by using blocks at an end of the electric-machine housing according to the present disclosure.

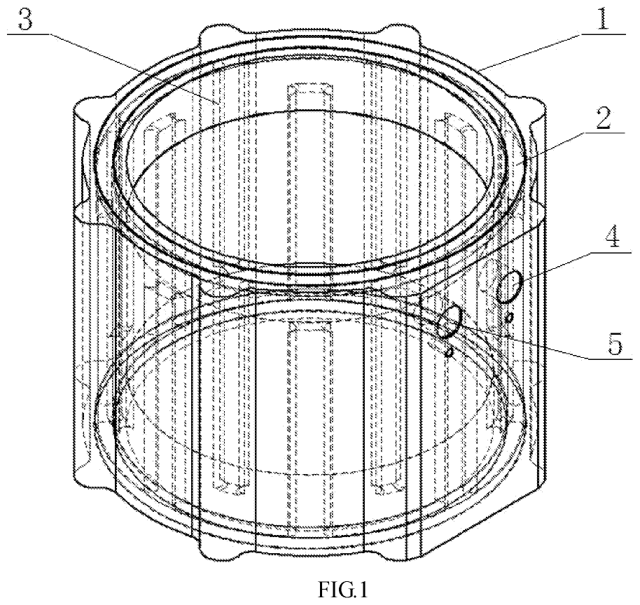

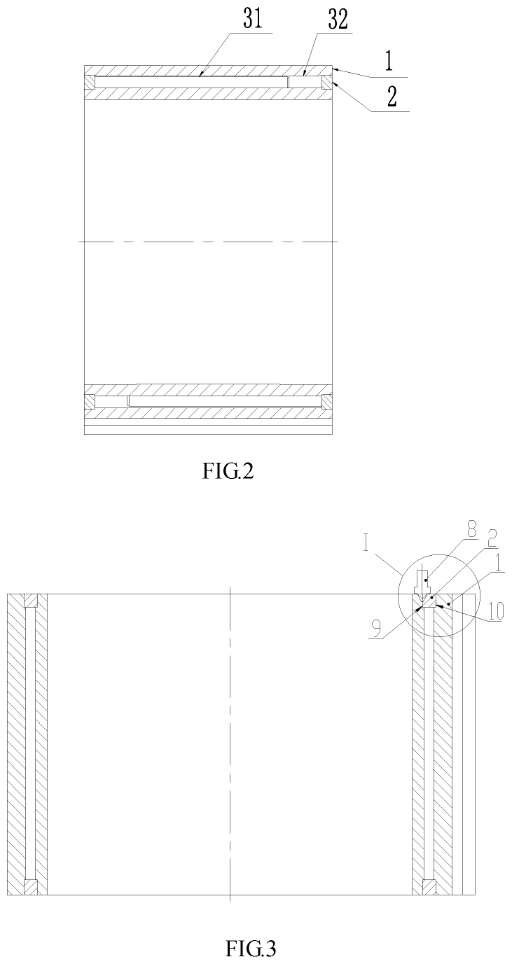

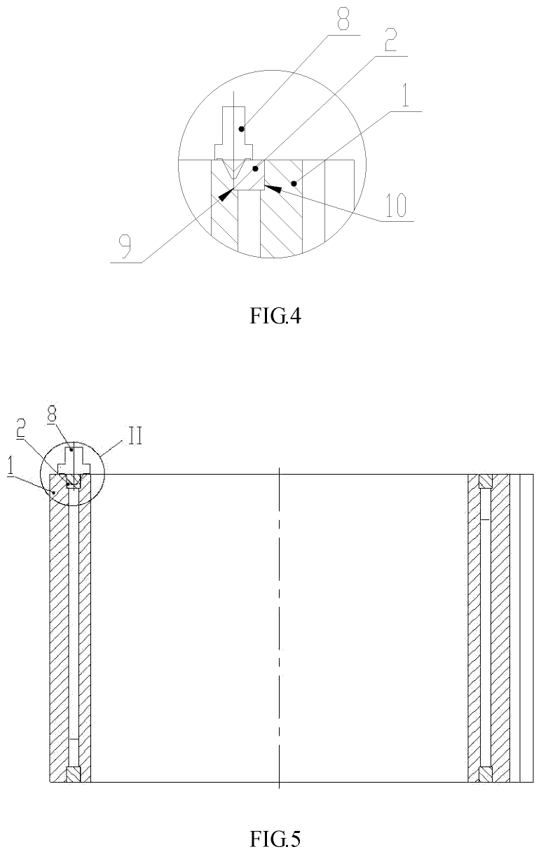

in the drawings: 1 is the electric-machine housing, 2 is the sealing part, 3 is the cooling-water channel, 31 is the axial water channel, 32 is the turning channel, 4 is the water inlet, 5 is the water outlet, 6 is an example of the sealing end blocks, 7 is an example of the sealing end ring, 8 is the friction-stir-welding stirring head, 9 is the welding seam I, and 10 is the welding seam II.

### DETAILED DESCRIPTION

In the water-channel structures of electric-machine housings the coolant flows in the axial direction, turns a U-turn at the ends, and flows throughout the electric-machine housing in an S shape. Sealing parts are welded to the two ends of the electric-machine housings to seal the water channels. The conventional welding mode is to sequentially weld the welding seams on both sides of the sealing parts, with a double-welding-seam mode. Such a welding mode has low operating efficiency, poor stability and long welding duration.

To tackle the problems of the conventional double-welding-seam mode which has low operating efficiency, poor stability and long welding duration, the present disclosure employs friction-stir welding, which can also be used to weld the sealing parts and seal the water channels. The present disclosure utilizes a larger stirring head to sufficiently stir-weld the sealing parts and the electric-machine housing all at once, i.e., welding with a single-welding-seam mode, so that the welding can be completed one time, and when compared with the conventional double-welding-seam mode (welding along the contour of the sealing end ring), has a higher efficiency, better stability, and reduced welding by ½ to ⅓.

In order to achieve the objectives, and present the technical solutions and the advantages of the present disclosure clearer, the present disclosure will be described below in detail in conjunction with the drawings and the particular embodiments.

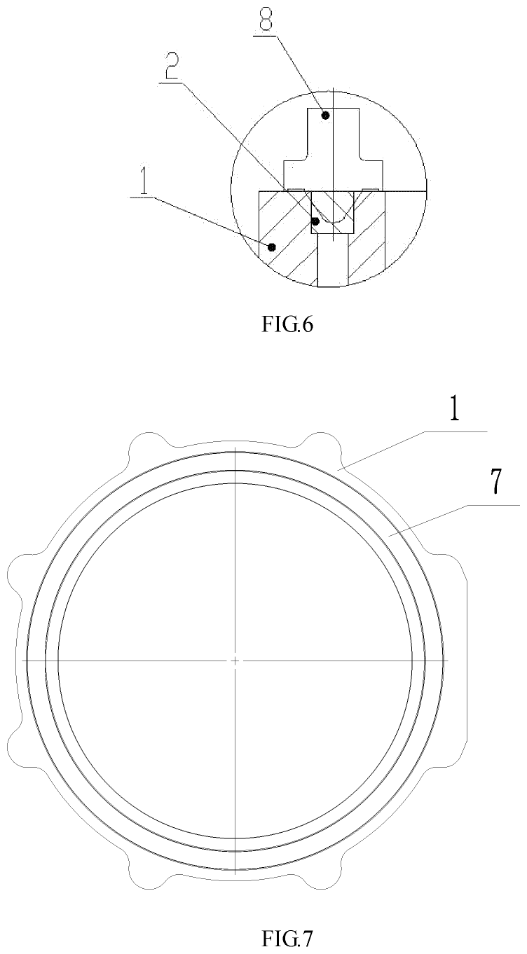

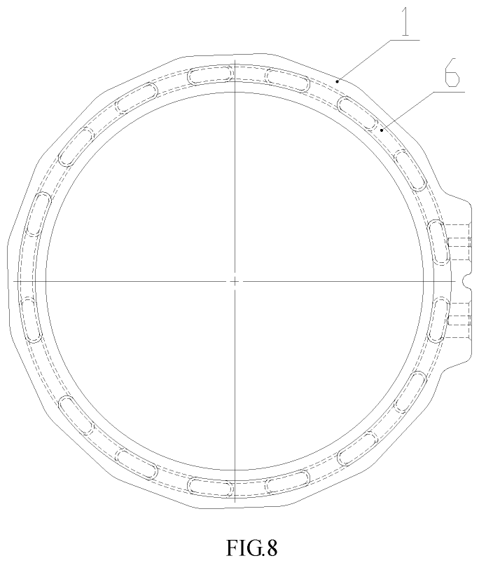

FIGS. 5-6 show a welding method for sealing a cooling-water channel of an electric-machine housing, wherein the method comprises the steps of:

1) seal the opened ends of the cooling-water channel using the sealing parts 2 to form an S-shaped sealed cooling water channel inside the electric-machine housing 1; and

2) weld each of the sealing parts 2 and the electric-machine-housing 1 together by using the friction-stir-welding head 8, in one single and complete single-welding-seam mode.

Optionally, in the step 1), sealing-part slots at the ends of the electric-machine housing 1 in a circumferential direction, wherein the sealing-part slots are located outside the turning channels 32, and the sealing parts 2 are placed inside the sealing-part slots.

Optionally, pilots for supporting the sealing parts 2 are provided at a suitable depth to create the turning channel 32 on the electric-machine housing 1 in order to limit the positions and support the sealing parts 2 during welding operation, thereby satisfying the requirements on the welding process.

In an embodiment of the present disclosure, sealing-part slots on the electric-machine housing can be machined out to place the sealing parts 2. The sealing parts 2 that are placed inside mentioned sealing-part slots are called sealing end rings 7, and the sealing end rings 7 are welded with the electric-machine housing 1 to create the turning channels 32 which seals and completes the S-shaped cooling-water channel inside the electric-machine housing 1. The friction-stir-welding stirring head 8 sufficiently stir-welds the sealing end rings 7 and the electric-machine-housing together in a single-welding-seam mode, which guarantees the sealing of the cooling-water channel and prevents the leakage of the coolant flowing inside the cooling-water channel.

In another embodiment of the present disclosure, multiple sealing slots, where each sealing slot is an independent slot of any shape, are located circumferentially on one or multiple layers on the electric-maching housing ends that corresponds to the shape and number of layers of water-cooling channels' design respectively, and the sealing part 2 that is placed inside these mentioned sealing slots are called sealing end blocks 6, whereby the different welding shapes can be better applied in housings of different cross-sectional shapes, as shown in FIG. 8. By using a number of sealing end blocks 6 to seal the turning channels 32, the cooling-water channel forms a complete S-shaped sealed channel. The friction-stir-welding stirring head 8 sufficiently stir-welds each sealing end blocks 6 and the electric-machine-housing 1 together, in a single-welding-seam mode, which guarantees the sealing of the cooling-water channel and prevents the leakage of the coolant flowing inside the cooling-water channel.

Two holes are made at the outer surface of the electric-machine housing 1, and are in communication with the inlet and the outlet of the cooling-water channel respectively, to form a water inlet 4 and a water outlet 5, to enable the coolant to be circulated, and cool the electric-machine housing.

The purpose of welding the sealing end rings or the sealing end blocks to the two ends of the electric-machine housing in the present disclosure is to seal the opened turning channels at the ends of the cooling-water channel, to form a complete S-shaped water channel, to prevent the leakage of the coolant.

The present disclosure utilizes the stirring head having a larger diameter to sufficiently stir-weld each of the sealing parts and the electric-machine housing all at once, i.e., welding in the single-welding-seam mode, so that the welding can be completed at one time, which, as compared with the conventional mode of double-welding-seam mode, has a higher operation efficiency, a better stability, and reduces welding duration by ½ to ⅓.

The above are merely embodiments of the present disclosure, and are not limiting the protection scope of the present disclosure. Any modifications, equivalent substitutions, improvements and extensions that are made within the spirit and principle of the present disclosure shall fall within the protection scope of the present disclosure.

What is claimed is:

1. A welding method for sealing a cooling-water channel of an electric-machine housing, wherein the method comprises the steps of:
1) seal the opened ends of the cooling-water channel using the sealing parts to form an S-shaped sealed cooling water channel inside the electric-machine housing; and
2) weld each of the sealing parts and the electric-machine-housing together by using the friction-stir-welding, in one single and complete single-welding-seam mode.

2. The welding method according to claim 1, wherein
the method further comprises, in the step 1), sealing-part slots at the ends of the electric-machine housing in a circumferential direction, wherein the sealing-part slots are located outside the turning channels, and the sealing parts are placed inside the sealing-part slots.

3. The welding method according to claim 2, wherein a pilot for supporting the sealing parts is provided at a suitable depth to create the turning channel on the electric-machine housing.

4. The welding method according to claim 2, wherein sealing-part slots on the electric-machine housing can be machined out to place the sealing parts. The sealing parts that are placed inside mentioned sealing-part slots are called sealing end rings, and the sealing end rings are welded with the electric-machine housing to create the turning channels.

5. The welding method according to claim 2, wherein multiple sealing slots, where each sealing slot is an independent slot of any shape, are located circumferentially on one or multiple layers on the electric-machine housing ends that corresponds to the shape, number of layers of water-cooling channels' design respectively, and the sealing part that is placed inside these mentioned sealing slots are called sealing end blocks.
